(19) United States
(12) Patent Application Publication
(10) Pub. No.: US 2026/0212257 A1
(43) Pub. Date: Jul. 23, 2026

(54) SOFTWARE DEVELOPMENT OBJECT ARTIFICIAL INTELLIGENCE TRAINING DATA GENERATION

(71) Applicant: SAP SE, Walldorf (DE)

(72) Inventors: Minh-Khanh Do, Leimen (DE); Manuel Berning, Dielheim (DE); Mikhail Yakovlev, Karlsdorf-Neuthard (DE); Felix Lorenz, Limburgerhof (DE); Fan Fei, Heidelberg (DE); Frank Bertelsmeier, Speyer (DE)

(21) Appl. No.: 19/035,012

(22) Filed: Jan. 23, 2025

(51) Int. Cl. G06N 20/00; G06F 8/30

(52) U.S. Cl. CPC G06N 20/00; G06F 8/30

(57) ABSTRACT

The present disclosure involves systems, software, and computer implemented methods for artificial intelligence (AI) training data generation. A method includes identifying a request to generate training data based on software development objects of a software development system. A plurality of exporters each configured for a given object type are invoked. Each exporter invokes a respective interface of the software development system to iterate, in a shared object repository, over objects of an object type to retrieve object data and object metadata for instances of the object type. Object data and object metadata are received from each exporter. Received object data and metadata are stored in a first format in an exported data repository. AI training data is generated by transforming the object data and metadata in the first format to a second format suitable for training AI models. The AI training data is provided to at least one AI system.

### BACKGROUND

Software development can involve or generate various types of artifacts. For example, application source code, including object/class-based source code and/or procedural-based source code can be developed. Some applications can use a database and application development can involve generation and/or use of various database artifacts, such as tables, views, and stored procedures.

### SUMMARY

The present disclosure describes software development object artificial intelligence training data generation.

In an implementation, a method includes identifying a request to generate artificial intelligence (AI) training data based on software development objects of a software development system. In response to the request to generate AI training data, a plurality of object-type-specific exporters each configured for a given object type are invoked. Each object-type-specific exporter invokes a respective interface of the software development system to iterate, in a shared object repository of the software development system, over objects of an object type of the object-type-specific exporter, to retrieve object data and object metadata for instances of the object type of the object-type-specific exporter. Object data and object metadata are received from each object-type-specific exporter of the plurality of object-type-specific exporters. Received object data and object metadata are stored in a first format in an exported data repository. AI training data is generated by transforming the object data and object metadata in the first format to a second structured format suitable for training AI models. The AI training data is provided to at least one AI system.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, an artificial intelligence (AI) training data generation system can automate the extraction of development objects from development systems for use in training AI models. Second, use of the AI training data generation system can reduce time, effort, errors, and resource use of data collection for AI model training as compared to other approaches. Third, the system can leverage specialized extractors for different development object types that are each specifically configured to extract data and metadata for instances of a certain object type. Fourth, the AI training data generation system can generate a comprehensive and structured data dump of development objects that is in a format suitable and useful for AI model training. Fifth, the solution can leverage a shared object repository in a distributed development environment for data extraction. Sixth, the training data generation solution can scale by flexibly handling new object instances of known object types and new, previously unknown object types.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating an example of a system for artificial intelligence training data generation, according to an implementation of the present disclosure. FIG. 2, according to an implementation of the present disclosure.

FIG. 2 is a block diagram illustrating an example of a training data generation system, according to an implementation of the present disclosure.

FIG. 3 is a flowchart illustrating an example of a computer-implemented method for software development object artificial intelligence training data generation, according to an implementation of the present disclosure.

FIG. 4 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes software development object artificial intelligence training data generation and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Software development can involve generation of various artifacts, such as class definitions, class implementations, interface definitions, table or view definitions, table or view creation scripts, etc. A developer may use various tools, such as editors, compilers, execution and testing environments, etc. A provider of software development frameworks or toolkits may desire to add artificial intelligence (AI) functionality to a software development environment. For example, AI functionality can be added to an ABAP (Advanced Business Application Programming) environment/system provided by SAP SE of Walldorf, Germany.

To sufficiently train an AI model for a particular development environment on tasks such as code completion/prediction or code explanation, a training data set can be generated that includes a comprehensive set of development objects such as existing classes, entity behavior definitions (e.g., for ABAP RAP (RESTful (Representational State Transfer) Application Programming) objects), programs, tables, views, etc. However, extracting relevant data and code snippets from systems such as systems for AI model training can be a manual, time-intensive, and potentially error-prone process that demands substantial technical expertise. As another example, a challenge for AI training data generation by a developer for a centralized environment, such as ABAP, is that objects reside not locally accessible to the developer, but rather on a central server. An individual developer or data scientist may not have means, access, or expertise to obtain a comprehensive set of training data from the central server. Such limitations can limit an ability of a data scientist to obtain necessary data for creating accurate and reliable AI models for development environments, thereby slowing innovations in automation, predictive analytics, and other AI-driven applications within such development environments.

To facilitate and enable generation of AI training data for development environments, an AI training data generation system can automate the extraction of development objects from ABAP and other systems for use in training AI models. The AI training data generation solution can streamline a data collection process and reduce the time and effort required to prepare complete and accurate data for AI model training. The training data generation system can simplify complex data extraction processes and thereby bridge a gap between software development and AI environments. The solution can support advancements in data-driven decision-making and automation within software development environments by generating trained AI solutions for those environments.

The AI training data generation system includes several advantageous aspects, including automated data extraction, modular and specialized extraction, a shared data repository, a structured data dump, and scalability and flexibility. The automated data extraction of the solution eliminates a need for and the limitations of manual data collection, thus reducing time, effort, and errors previously involved with manual collection efforts. The modular and specialized extraction of the solution can include use of specialized extractors for different development object types (e.g., ABAP classes, programs, tables, views, etc.), with each specialized extractor being specifically configured to extract data and metadata for instances of a certain object type.

The solution generates a structured data dump for AI model training. For example, extracted data can be transformed into a structured format suitable and useful for AI model training, ensuring that data scientists have access to clean, reliable data for developing accurate and efficient AI models. The solution can leverage a shared object repository in distributed development environments to extract, for example, a complete set of relevant data and code snippets for the development environment. By extracting data from the shared object repository, the solution can enable data scientists to access and use a centralized source of development object information for AI model training.

The training data generation solution is designed for scalability and flexibility. For example, the solution is designed to scale with a growing volume of development objects and adapt to changes in the development environment, thus providing data scientists with a flexible and scalable platform for AI model training. The solution can flexibly scale to handle new object instances of known object types and extraction of data new object types.

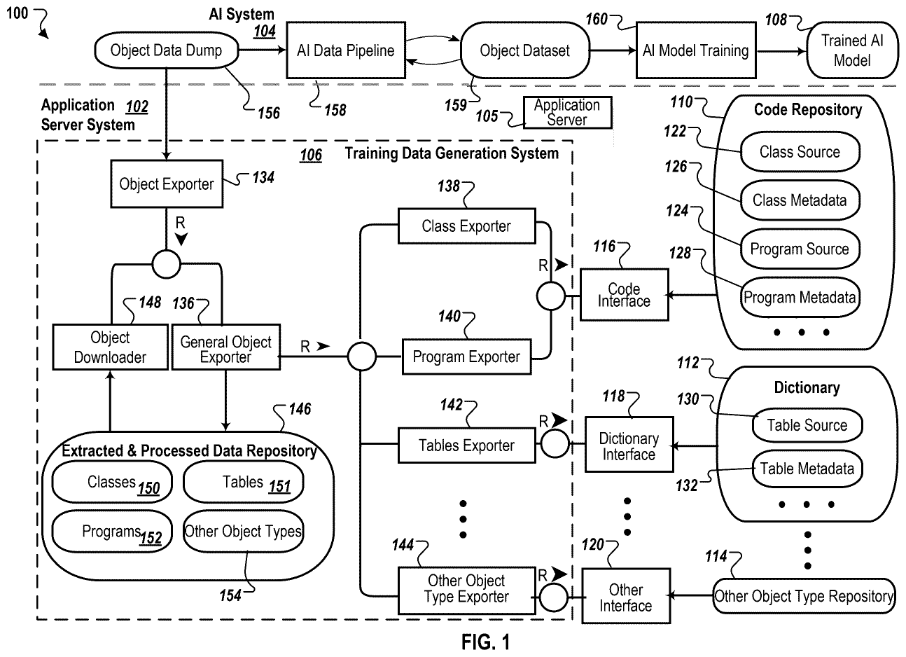

FIG. 1 is a block diagram illustrating an example of a system 100 for artificial intelligence training data generation, according to an implementation of the present disclosure. The system 100 includes an application server system 102 and an AI system 104. Although shown separately, in some implementations, the AI system 104 may be a component of the application server system 102. Although only a single AI system 104 is shown, the application server system 102 can interface with multiple AI systems. The application server system 102 may be, for example, an ABAP system. The application server system 102 can include an application server 105 and other associated systems or tools.

The application server system 102, or more particularly a training data generation system 106 included in or otherwise associated with the application server system 102, can automatically generate AI training data for use in the AI system 104 for generating a trained AI model 108 based on a comprehensive data set that includes object data and object metadata of objects (e.g., ABAP objects) in the application server system 102. The application server system 102 can include one or more central repositories where application server (e.g., ABAP) artifacts are stored. The centralized repository approach of the application server system 102 can prove advantageous for generating application server object AI training data as compared to other development environments where artifacts may reside locally on different servers or developer systems in a landscape in which a location of all artifacts may be unknown.

Centralized repositor(y/ies) of the application server system 102 can store, for example, classes, programs, tables, views, documentation, etc., along with metadata for those objects. As illustrated, the application server system 102 includes a code repository 110, a dictionary 112 (e.g., database), and possibly one or more other-object-type repositories 114 (e.g., documentation repositories).

Object data and object metadata may be retrievable using different interfaces provided by the application server system 102. For example, the application server system 102 provides or includes a code interface 116, a dictionary interface 118 (e.g., database interface), and one or more other interfaces 120. Each of the code interface 116, dictionary interface 118, and other interfaces 120 may be an API (Application Programming Interface), for example.

The application server system 102 (and associated repositories) can have characteristics (e.g., context) that distinguish the application server system 102 from other application server system instances. For example, the application server system 102 can include a particular version of the application server 105, a particular version of a code release (e.g., an ABAP code release version), a particular type of database (e.g., SAP HANA (High-performance ANalytic Appliance) provided by SAP SE of Walldorf, Germany, a particular database version, particular documentation versions, etc. Furthermore, the application server system 102 may be configured for a particular customer (e.g., as an on-premises solution and/or as a particular customer instance of a cloud environment). The customer and/or partners that provide solutions on behalf of the customer may have included, in the application server system 102, different types of customer-specific extensions, such as customer custom code, custom database objects, etc., to extend a standard implementation.

The code repository 110 can include different types of code objects. For example, the code repository 110 includes class source code 122, program source code 124, and possibly other types of source code. The code repository 110 can include metadata for different types of code objects. For instance, the code repository 110 includes class metadata 126 and program metadata 128. Code metadata can include information that indicates when a code object was created and/or last modified, an object owner or creator, a current version, code deltas associated with prior versions, etc. Although the code repository 110 can include certain types of code metadata that may be obtained using the code interface 116, other types of metadata may be programmatically generated, as described for specific object type exporters.

The dictionary 112 can include different types of data objects (e.g., ABAP dictionary objects). For example, the dictionary 112 includes table source objects 130, table metadata 132, and other data objects and metadata (not shown), such as view source objects and view metadata. The other-object-type repository 114 can include other types of objects, such as documentation objects. The documentation objects can provide documentation for code objects and/or dictionary objects, for example. Each object type, whether code, dictionary, documentation, etc., can include information useful for AI training.

The training data generation system 106 can generate AI training data from data in the code repository 110, the dictionary 112, and possibly from the other-object-type repository 114. Data generated by the training data generation system 106 can be provided to any generic AI pipeline, such as the AI system 104 and/or other AI systems.

An object exporter 134 can be used to trigger a training data generation in the training data generation system 106. For example, the AI system 104 can send a request for training data generation to the object exporter 134. As another example, training data generation can be triggered in or by the object exporter 134 as part of periodic or scheduled processing. As another example, the object exporter 134 can have a user interface that enables an administrator to trigger a training data generation and export. Training data generation can occur on demand, as noted, or in response to a release of a new version or new instances of one or more items (e.g., code, server, and/or database) in the application server system 102.

In some cases, a trigger to request training data generation can include specification of filter criteria that can cause the training data generation system 106 to filter generated training data according to the filter criteria. Filters can include, for example, object type, object location (e.g., package name), last-changed-timestamp (e.g., to obtain a delta of new or changed objects), etc.

The object exporter 134 can invoke a general object exporter 136. The general object exporter 136, in turn, can invoke a set of object-type-specific exporters. For example, the general object exporter 136 can invoke a class exporter 138 to trigger export of class data and class metadata, a program exporter 140 to trigger export of program data and program metadata, a tables exporter 142 to trigger export of table data and table metadata, an other-object-type exporter 144 to trigger export of data of another object type (e.g., documentation), and possibly other exporters (e.g., a view exporter). In some implementations, the general object exporter 136 can include functionality common to multiple object-type-specific exporters, and a given object-type-specific exporter (e.g., the class exporter 138) can perform a call-back (or invoke common functionality via inheritance, as another example) to the general object exporter 136 to invoke the common functionality.

In general, however, each object-type-specific exporter can be configured to extract object data and object metadata specific to a particular object type. A given object-type-specific exporter can be configured to handle unique attributes of a given object type, including data/metadata location in a repository, methods of navigating and retrieving object-type data/metadata from the application server system 102, and specific data/metadata of instances of the object type to retrieve.

The class exporter 138, for example, can be configured to locate and retrieve, using the code interface 116, source code and metadata for each class included in the application server system 102. Similarly, the program exporter 140 can be configured to locate and retrieve, using the code interface 116, source code and metadata for each program included in the application server system 102. The class exporter 138 and the program exporter 140 can be configured to retrieve certain class or program metadata, respectively, from the code repository using the code interface 116. The class exporter 138 and/or the program exporter 140 can also be configured to programmatically generate certain class or program metadata, for example, beyond retrieval of existing metadata using the code interface 116. For example, class code extracted by the class exporter 138 for a class can be provided to a syntax checker and the syntax checker can check the syntax of the code with respect to multiple language versions. Different language keywords may be allowed or disallowed in different language versions of a programming language, for example. The class exporter 138 can collect results (e.g., syntax errors and warnings) of the syntax check on different languages and save the results as additional class metadata for the class.

The tables exporter 142 can be configured to retrieve, using the dictionary interface 118, table definitions and table metadata from the dictionary 112. For example, in some implementations, the tables exporter 142 can be configured to request data for certain predefined tables (e.g., system tables). The tables exporter 142 can, additionally or alternatively, be configured to retrieve table definitions and table metadata of each table in the dictionary 112 (or tables of certain types (e.g., standard tables, customer-specific tables, etc.)). In some examples, the tables exporter 142 may export form-based artifacts (e.g., artifacts not editable in a textual representation). In some cases and for some tables, the tables exporter 142 may export table data (e.g., while complying with any applicable personal data considerations).

The training data generation system 106 is an extensible system that supports additions of new exporters for new object types. For example, if a future version of the application server system 102 includes or supports a new object type for which data may be useful for AI training, a new exporter specific to the new object type can be developed and configured, with minimal changes to the training data generation system 106. For example, the existing exporters (e.g., the class exporter 138, the program exporter 140, the tables exporter 142, and the other-object-type exporter 144 can remain unchanged. The general object exporter 136 can be modified to include a call to the new exporter.

During a particular data export, the general object exporter 136 can, in response to invocations of the specific-object-type exporters, receive object data and object metadata from each specific-object-type exporter. The general object exporter 136 can store (or can request to store) gathered data from each specific-object-type exporter in an extracted and processed data repository 146. The general object exporter 136 can store data from specific-object-type exporters in a first format that is known to an object downloader 148. The first format can be a raw format not yet suitable (or in a non-preferred format) for use in AI training. The extracted and processed data repository 146 includes, as shown, class data 150 (e.g., ABAP class data), table data 151 (e.g., ABAP table data), program data 152 (e.g., ABAP program data), and other data 154 (e.g., documentation for ABAP classes, programs, and/or dictionary objects) in the first format. The extracted and processed data repository 146 can be in or as a database of the application server system 102 which may be a different portion of a same repository as the code repository 110 and/or the dictionary 112 or which may be a repository separate from the code repository 110 and the dictionary 112.

The object downloader 148 can transform the raw data in the first format in the extracted and processed data repository 146 into extracted and processed data repository 146 a second format (e.g., JSON (JavaScript Object Notation) or XML (eXtensible Markup Language)) known to, and usable in, the AI system 104. The second format can be an agreed-upon format understood by both the training data generation system 106 and the AI system 104, for example. Although described as being performed by the object downloader 148, some or all of the transformation of object data and object metadata in the extracted and processed data repository 146 can be performed by the object exporter 134.

The object exporter 134 can provide data in the second format to the AI system 104 as an object data dump 156. The object data dump 156 can be provided to other AI systems (e.g., the object data dump 156 can be provided to any AI system or pipeline). The object data dump 156, as an output of the training data generation system 106, can provide a complete picture of the state of the application server system 102 at a given point in time (e.g., at the time of the export). The object data dump 156 (and possibly other object data dumps from other application server systems) can be used in an AI data pipeline 158 of the AI system 104.

In some implementations and/or for some instances of the object data dump 156, a portion of the AI data pipeline 158 may format data in the object data dump 156 into a third format as an object data set 159 formatted for use by an AI model training component 160 of the AI system. The AI model training component 160 can use the object data set 159 to train an AI model, resulting in generation of the trained AI model 108. The trained AI model 108 can be trained to perform code completion, code prediction, code explanation, or other activities related to objects (e.g., ABAP objects such as classes, programs, and dictionary objects) of the application server system 102.

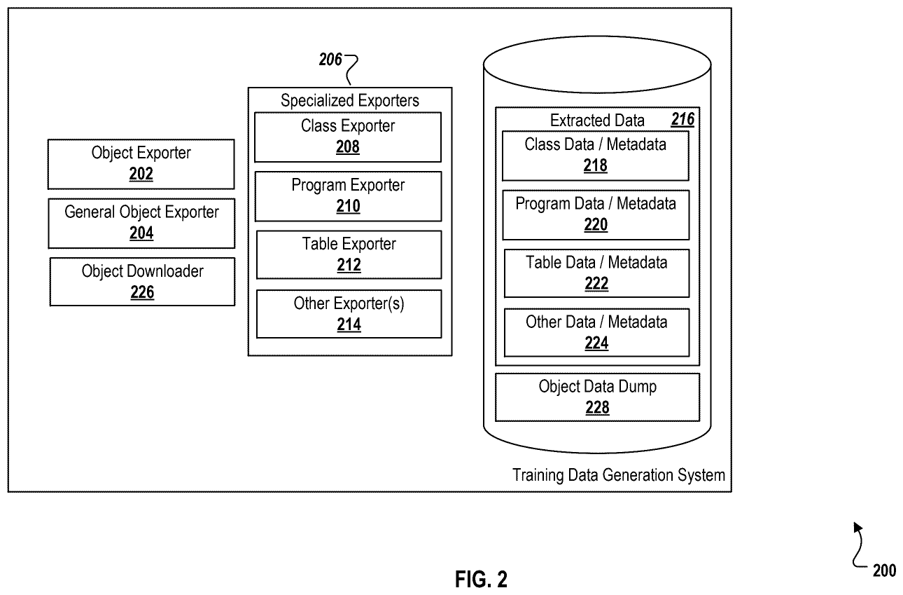

FIG. 2 is a block diagram illustrating an example of a training data generation system 200, according to an implementation of the present disclosure. The training data generation system 200 can automatically generate AI training data for use in AI systems or environments.

An object exporter 202 can be used to trigger a training data generation in the training data generation system 200, in response to receipt of a request or in response to an event generated as part of scheduled or periodic automatic processing. In response to a trigger to generate training data, the object exporter 202 can invoke a general object exporter 204. The general object exporter 204, in turn, can invoke a set of specialized object-type-specific exporters 206. For example, the general object exporter 204 can invoke a class exporter 208 to trigger export of class data and class metadata, a program exporter 210 to trigger export of program data and program metadata, a tables exporter 212 to trigger export of table data and table metadata, and possibly one or more other exporters 214 to trigger export of data of other object type(s) (e.g., views and/or documentation).

Each specialized object-type-specific exporter 206 can be configured to extract object data and object metadata specific to a particular object type. A given object-type-specific exporter can be configured to handle unique attributes of a given object type, including methods of navigating and retrieving object-type data/metadata from an application server system (e.g., the application server system 102), and specific data/metadata of instances of the object type to retrieve. For example, each specialized object-type-specific exporter 206 can invoke a particular interface of the application server system to request object data and object metadata of the object type of the exporter. In some implementations, some or all of the object-type-specific exporters 206 are configured to programmatically generate at least some object metadata.

During a particular data export, the general object exporter 204 can, in response to invocations of the specialized object-type-specific exporters 206, receive object data and object metadata from each specialized object-type-specific exporter 206. The general object exporter 204 can store gathered data from each specialized object-type-specific exporter 206 in an extracted data repository 216. For example, the extracted data repository 216 includes class data and metadata 218 obtained from the class exporter 208, program data and metadata 220 obtained from the program exporter 210, table data and metadata 222 obtained from the table exporter 212, and other data and metadata 224 obtained from one or more other exporters 214.

The general object exporter 204 can store data from exporters in a first format that is known to an object downloader 226. The first format can be a raw format not yet suitable (or in a non-preferred format) for use in AI training. The object downloader 226 (and/or the object exporter 202) can transform the raw data in the first format in the extracted data repository 216 into an object data dump 228 that is in second format (e.g., JSON or XML) known to and usable in an AI system (e.g., the AI system 104). The second format can be an agreed-upon format understood by both the training data generation system 106 and the AI system, for example.

The object exporter 202 can provide the object data dump 228 to one or more AI systems. The object data dump 228, as an output of the training data generation system 200, can provide a complete picture of the state of a development environment at a time of the export). The object data dump 228 (and possibly other object data dumps from other application server systems) can be used for AI training, to generate a trained AI model that can be used in the development environment.

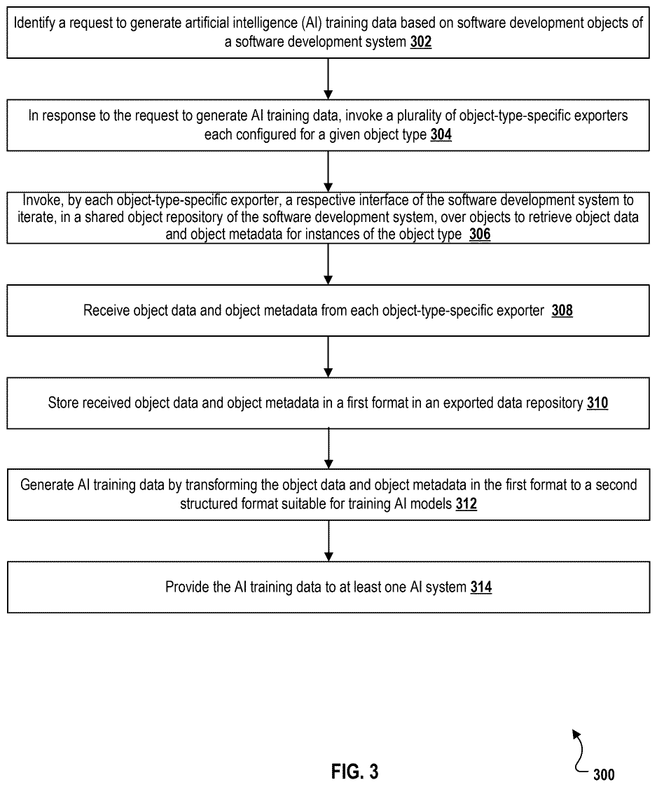

FIG. 3 is a flowchart illustrating an example of a computer-implemented method 300 for software development object artificial intelligence training data generation, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order.

At 302, a request is identified to generate artificial intelligence (AI) training data based on software development objects of a software development system. The request can be identified based on a new version of the software development system or a new version of a software development object of the software development system. As another example, the request can be identified based on scheduled training data generation. Software development objects can include classes, programs, tables, views, and artifact documentation. Software development objects can be ABAP, CDS (Core Data Service), data dictionary, or RAP objects. The software development system can be an ABAP system. From 302, method 300 proceeds to 304.

At 304, in response to the request to generate AI training data, a plurality of object-type-specific exporters are invoked where each object-type-specific exporter is configured for a given object type. From 304, method 300 proceeds to 306.

At 306, each object-type-specific exporter invokes a respective interface of the software development system to iterate, in a shared object repository of the software development system, over objects of an object type of the object-type-specific exporter, to retrieve object data and object metadata for instances of the object type of the object-type-specific exporter. Object metadata can include object ownership information, object creation information, and object modification information. In some cases, an exporter can automatically generate some object metadata as well as retrieving other object metadata. From 306, method 300 proceeds to 308.

At 308, object data and object metadata are received from each object-type-specific exporter of the plurality of object-type-specific exporters. From 308, method 300 proceeds to 310.

At 310, received object data and object metadata are stored in a first format in an exported data repository. From 310, method 300 proceeds to 312.

At 312, AI training data is generated by transforming the object data and object metadata in the first format to a second structured format suitable for training AI models. The second structured format can be a JavaScript Object Notation format or an eXtensible Markup Language format. From 312, method 300 proceeds to 314.

At 314, the AI training data is provided to at least one AI system. After 314, method 300 can stop. In some implementations, the method can include training, using the AI training data, an AI model of the AI system. Training the AI model can include training the AI model to generate a code completion prediction in the software development system and/or training the model to explain a portion of code in the software development system.

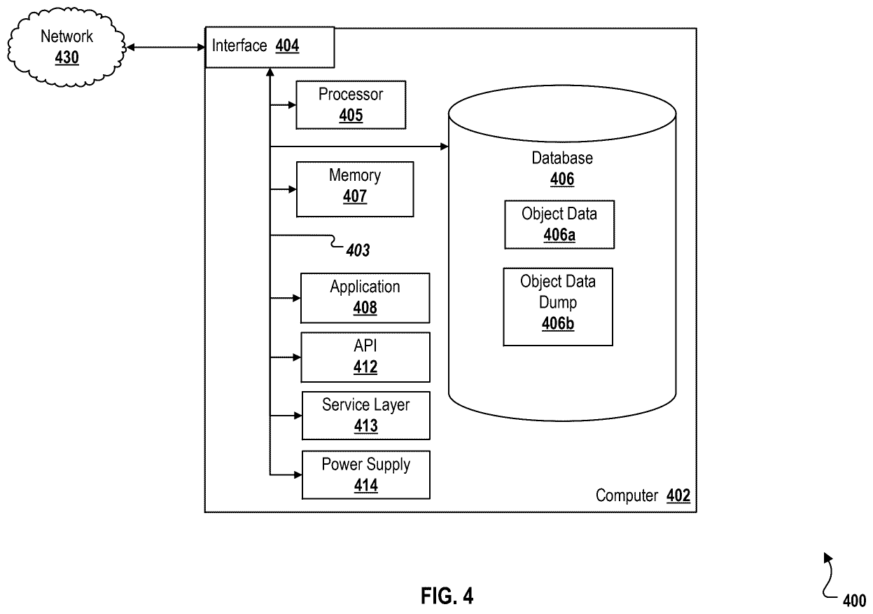

FIG. 4 is a block diagram illustrating an example of a computer-implemented System 400 used to provide computational functionalities associated with described algorithms, methods, functions, processes, flows, and procedures, according to an implementation of the present disclosure. In the illustrated implementation, computer-implemented system 400 includes a Computer 402 and a Network 430.

The illustrated Computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 402 can include an input device, such as a keypad, keyboard, or touch screen, or a combination of input devices that can accept user information, and an output device that conveys information associated with the operation of the Computer 402, including digital data, visual, audio, another type of information, or a combination of types of information, on a graphical-type user interface (UI) (or GUI) or other UI.

The Computer 402 can serve in a role in a distributed computing system as, for example, a client, network component, a server, or a database or another persistency, or a combination of roles for performing the subject matter described in the present disclosure. The illustrated Computer 402 is communicably coupled with a Network 430. In some implementations, one or more components of the Computer 402 can be configured to operate within an environment, or a combination of environments, including cloud-computing, local, or global.

At a high level, the Computer 402 is an electronic computing device operable to receive, transmit, process, store, or manage data and information associated with the described subject matter. According to some implementations, the Computer 402 can also include or be communicably coupled with a server, such as an application server, e-mail server, web server, caching server, or streaming data server, or a combination of servers.

The Computer 402 can receive requests over Network 430 (for example, from a client software application executing on another Computer 402) and respond to the received requests by processing the received requests using a software application or a combination of software applications. In addition, requests can also be sent to the Computer 402 from internal users (for example, from a command console or by another internal access method), external or third-parties, or other entities, individuals, systems, or computers.

Each of the components of the Computer 402 can communicate using a System Bus 403. In some implementations, any or all of the components of the Computer 402, including hardware, software, or a combination of hardware and software, can interface over the System Bus 403 using an application programming interface (API) 412, a Service Layer 413, or a combination of the API 412 and Service Layer 413. The API 412 can include specifications for routines, data structures, and object classes. The API 412 can be either computer-language independent or dependent and refer to a complete interface, a single function, or even a set of APIs. The Service Layer 413 provides software services to the Computer 402 or other components (whether illustrated or not) that are communicably coupled to the Computer 402. The functionality of the Computer 402 can be accessible for all service consumers using the Service Layer 413. Software services, such as those provided by the Service Layer 413, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 402, alternative implementations can illustrate the API 412 or the Service Layer 413 as stand-alone components in relation to other components of the Computer 402 or other components (whether illustrated or not) that are communicably coupled to the Computer 402. Moreover, any or all parts of the API 412 or the Service Layer 413 can be implemented as a child or a sub-module of another software module, enterprise application, or hardware module without departing from the scope of the present disclosure.

The Computer 402 includes an Interface 404. Although illustrated as a single Interface 404, two or more Interfaces 404 can be used according to particular needs, desires, or particular implementations of the Computer 402. The Interface 404 is used by the Computer 402 for communicating with another computing system (whether illustrated or not) that is communicatively linked to the Network 430 in a distributed environment. Generally, the Interface 404 is operable to communicate with the Network 430 and includes logic encoded in software, hardware, or a combination of software and hardware. More specifically, the Interface 404 can include software supporting one or more communication protocols associated with communications such that the Network 430 or hardware of Interface 404 is operable to communicate physical signals within and outside of the illustrated Computer 402.

The Computer 402 includes a Processor 405. Although illustrated as a single Processor 405, two or more Processors 405 can be used according to particular needs, desires, or particular implementations of the Computer 402. Generally, the Processor 405 executes instructions and manipulates data to perform the operations of the Computer 402 and any algorithms, methods, functions, processes, flows, and procedures as described in the present disclosure.

The Computer 402 also includes a Database 406 that can hold data for the Computer 402, another component communicatively linked to the Network 430 (whether illustrated or not), or a combination of the Computer 402 and another component. For example, Database 406 can be an in-memory or conventional database storing data consistent with the present disclosure. In some implementations, Database 406 can be a combination of two or more different database types (for example, a hybrid in-memory and conventional database) according to particular needs, desires, or particular implementations of the Computer 402 and the described functionality. Although illustrated as a single Database 406, two or more databases of similar or differing types can be used according to particular needs, desires, or particular implementations of the Computer 402 and the described functionality. While Database 406 is illustrated as an integral component of the Computer 402, in alternative implementations, Database 406 can be external to the Computer 402. The Database 406 can hold and operate on at least any data type mentioned or any data type consistent with this disclosure. For example, the database 406 includes object data 406a (e.g., class, program, table data, etc.) and an object data dump 406b (e.g., formatted object data suitable for AI model training).

The Computer 402 also includes a Memory 407 that can hold data for the Computer 402, another component or components communicatively linked to the Network 430 (whether illustrated or not), or a combination of the Computer 402 and another component. Memory 407 can store any data consistent with the present disclosure. In some implementations, Memory 407 can be a combination of two or more different types of memory (for example, a combination of semiconductor and magnetic storage) according to particular needs, desires, or particular implementations of the Computer 402 and the described functionality. Although illustrated as a single Memory 407, two or more Memories 407 or similar or differing types can be used according to particular needs, desires, or particular implementations of the Computer 402 and the described functionality. While Memory 407 is illustrated as an integral component of the Computer 402, in alternative implementations, Memory 407 can be external to the Computer 402.

The Application 408 is an algorithmic software engine providing functionality according to particular needs, desires, or particular implementations of the Computer 402, particularly with respect to functionality described in the present disclosure. For example, Application 408 can serve as one or more components, modules, or applications. Further, although illustrated as a single Application 408, the Application 408 can be implemented as multiple Applications 408 on the Computer 402. In addition, although illustrated as integral to the Computer 402, in alternative implementations, the Application 408 can be external to the Computer 402.

The Computer 402 can also include a Power Supply 414. The Power Supply 414 can include a rechargeable or non-rechargeable battery that can be configured to be either user- or non-user-replaceable. In some implementations, the Power Supply 414 can include power-conversion or management circuits (including recharging, standby, or another power management functionality). In some implementations, the Power Supply 414 can include a power plug to allow the Computer 402 to be plugged into a wall socket or another power source to, for example, power the Computer 402 or recharge a rechargeable battery.

There can be any number of Computers 402 associated with, or external to, a computer system containing Computer 402, each Computer 402 communicating over Network 430. Further, the term “client,” “user,” or other appropriate terminology can be used interchangeably, as appropriate, without departing from the scope of the present disclosure. Moreover, the present disclosure contemplates that many users can use one Computer 402, or that one user can use multiple computers 402.

Described implementations of the subject matter can include one or more features, alone or in combination.

For example, in a first implementation, a method includes identifying a request to generate artificial intelligence (AI) training data based on software development objects of a software development system. In response to the request to generate AI training data, a plurality of object-type-specific exporters each configured for a given object type are invoked. Each object-type-specific exporter invokes a respective interface of the software development system to iterate, in a shared object repository of the software development system, over objects of an object type of the object-type-specific exporter, to retrieve object data and object metadata for instances of the object type of the object-type-specific exporter. Object data and object metadata are received from each object-type-specific exporter of the plurality of object-type-specific exporters. Received object data and object metadata are stored in a first format in an exported data repository. AI training data is generated by transforming the object data and object metadata in the first format to a second structured format suitable for training AI models. The AI training data is provided to at least one AI system.

In a second implementation, a non-transitory, computer-readable medium stores one or more instructions executable by a computer system to perform one or more operations. The operations include identifying a request to generate artificial intelligence (AI) training data based on software development objects of a software development system. In response to the request to generate AI training data, a plurality of object-type-specific exporters each configured for a given object type are invoked. Each object-type-specific exporter invokes a respective interface of the software development system to iterate, in a shared object repository of the software development system, over objects of an object type of the object-type-specific exporter, to retrieve object data and object metadata for instances of the object type of the object-type-specific exporter. Object data and object metadata are received from each object-type-specific exporter of the plurality of object-type-specific exporters. Received object data and object metadata are stored in a first format in an exported data repository. AI training data is generated by transforming the object data and object metadata in the first format to a second structured format suitable for training AI models. The AI training data is provided to at least one AI system.

In a third implementation, a computer-implemented system comprises one or more computers and one or more computer memory devices interoperably coupled with the one or more computers and having tangible, non-transitory, machine-readable media storing one or more instructions that, when executed by the one or more computers, perform one or more operations. The operations include identifying a request to generate artificial intelligence (AI) training data based on software development objects of a software development system. In response to the request to generate AI training data, a plurality of object-type-specific exporters each configured for a given object type are invoked. Each object-type-specific exporter invokes a respective interface of the software development system to iterate, in a shared object repository of the software development system, over objects of an object type of the object-type-specific exporter, to retrieve object data and object metadata for instances of the object type of the object-type-specific exporter. Object data and object metadata are received from each object-type-specific exporter of the plurality of object-type-specific exporters. Received object data and object metadata are stored in a first format in an exported data repository. AI training data is generated by transforming the object data and object metadata in the first format to a second structured format suitable for training AI models. The AI training data is provided to at least one AI system.

The foregoing and other described implementations can each, optionally, include one or more of the following features:
A first feature, combinable with any of the following features, wherein the request is identified based on a new version of the software development system or a new version of a software development object of the software development system.
A second feature, combinable with any of the previous or following features, wherein software development objects include classes, programs, tables, views, and artifact documentation.
A third feature, combinable with any of the previous or following features, wherein the software development system is an ABAP (Advanced Business Application Programming) system.
A fourth feature, combinable with any of the previous or following features, wherein software development objects include ABAP classes, programs, tables, and views.
A fifth feature, combinable with any of the previous or following features, wherein the object metadata comprises object ownership information, object creation information, and object modification information.
A sixth feature, combinable with any of the previous or following features, wherein a first object-type-specific exporter automatically generates at least some of the object metadata for the given object type of the first object-type-specific exporter.
A seventh feature, combinable with any of the previous or following features, wherein automatically generating metadata comprises: providing code for a first object to a syntax checker and requesting a syntax check for different language versions; receiving different syntax check results for different language version syntax checks; and saving the different syntax check results as object metadata for the object.
An eighth feature, combinable with any of the previous or following features, wherein the second structured format is a JavaScript Object Notation format or an eXtensible Markup Language format.
A ninth feature, combinable with any of the previous or following features, wherein an AI model of the AI system is trained using the AI training data.
A tenth feature, combinable with any of the previous or following features, wherein training the AI model comprises training the AI model to generate a code completion prediction in the software development system.
An eleventh feature, combinable with any of the previous or following features, wherein training AI model comprises training the model to explain a portion of code in the software development system.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
identifying a request to generate artificial intelligence (AI) training data based on software development objects of a software development system;
in response to the request to generate AI training data, invoking a plurality of object-type-specific exporters each configured for a given object type;
invoking, by each object-type-specific exporter, a respective interface of the software development system to iterate, in a shared object repository of the software development system, over objects of an object type of the object-type-specific exporter, to retrieve object data and object metadata for instances of the object type of the object-type-specific exporter;
receiving object data and object metadata from each object-type-specific exporter of the plurality of object-type-specific exporters;
storing received object data and object metadata in a first format in an exported data repository;
generating AI training data by transforming the object data and object metadata in the first format to a second structured format suitable for training AI models; and
providing the AI training data to at least one AI system.

2. The computer-implemented method of claim 1, wherein the request is identified based on a new version of the software development system or a new version of a software development object of the software development system.

3. The computer-implemented method of claim 1, wherein software development objects include classes, programs, tables, views, and artifact documentation.

4. The computer-implemented method of claim 1, wherein the software development system is an ABAP (Advanced Business Application Programming) system.

5. The computer-implemented method of claim 4, wherein software development objects include ABAP classes, programs, tables, and views.

6. The computer-implemented method of claim 1, wherein the object metadata comprises object ownership information, object creation information, and object modification information.

7. The computer-implemented method of claim 1, wherein a first object-type-specific exporter automatically generates at least some of the object metadata for the given object type of the first object-type-specific exporter.

8. The computer-implemented method of claim 7, wherein automatically generating metadata comprises:
providing code for a first object to a syntax checker and requesting a syntax check for different language versions;
receiving different syntax check results for different language version syntax checks; and
saving the different syntax check results as object metadata for the object.

9. The computer-implemented method of claim 1, wherein the second structured format is a JavaScript Object Notation format or an eXtensible Markup Language format.

10. The computer-implemented method of claim 1, further comprising training, using the AI training data, an AI model of the AI system.

11. The computer-implemented method of claim 10, wherein training the AI model comprises training the AI model to generate a code completion prediction in the software development system.

12. The computer-implemented method of claim 10, wherein training AI model comprises training the model to explain a portion of code in the software development system.

13. A non-transitory, computer-readable medium storing one or more instructions executable by a computer system to perform one or more operations, comprising:
identifying a request to generate artificial intelligence (AI) training data based on software development objects of a software development system;
in response to the request to generate AI training data, invoking a plurality of object-type-specific exporters each configured for a given object type;
invoking, by each object-type-specific exporter, a respective interface of the software development system to iterate, in a shared object repository of the software development system, over objects of an object type of the object-type-specific exporter, to retrieve object data and object metadata for instances of the object type of the object-type-specific exporter;
receiving object data and object metadata from each object-type-specific exporter of the plurality of object-type-specific exporters;
storing received object data and object metadata in a first format in an exported data repository;
generating AI training data by transforming the object data and object metadata in the first format to a second structured format suitable for training AI models; and
providing the AI training data to at least one AI system.

14. The computer-readable medium of claim 13, wherein the software development system is an ABAP (Advanced Business Application Programming) system.

15. The computer-readable medium of claim 14, wherein software development objects include ABAP classes, programs, tables, and views.

16. The computer-readable medium of claim 13, wherein the object metadata comprises object ownership information, object creation information, and object modification information.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
identifying a request to generate artificial intelligence (AI) training data based on software development objects of a software development system;
in response to the request to generate AI training data, invoking a plurality of object-type-specific exporters each configured for a given object type;
invoking, by each object-type-specific exporter, a respective interface of the software development system to iterate, in a shared object repository of the software development system, over objects of an object type of the object-type-specific exporter, to retrieve object data and object metadata for instances of the object type of the object-type-specific exporter;
receiving object data and object metadata from each object-type-specific exporter of the plurality of object-type-specific exporters;
storing received object data and object metadata in a first format in an exported data repository;
generating AI training data by transforming the object data and object metadata in the first format to a second structured format suitable for training AI models; and
providing the AI training data to at least one AI system.

18. The computer-implemented system of claim 17, wherein the software development system is an ABAP (Advanced Business Application Programming) system.

19. The computer-implemented system of claim 18, wherein software development objects include ABAP classes, programs, tables, and views.

20. The computer-implemented system of claim 17, wherein the object metadata comprises object ownership information, object creation information, and object modification information.
